(19) United States
(12) Patent Application Publication
(10) Pub. No.: US 2018/0367684 A1
(43) Pub. Date: Dec. 20, 2018

(54) INFORMATION PROCESSING DEVICE, PROGRAM, CUT SETTING METHOD USING INFORMATION PROCESSING DEVICE, AND PRINTING SYSTEM

(71) Applicant: SEIKO EPSON CORPORATION, Tokyo (JP)

(72) Inventor: Akinori TSUJI, Shiojiri-Shi (JP)

(73) Assignee: SEIKO EPSON CORPORATION, Tokyo (JP)

(21) Appl. No.: 16/060,348

(22) PCT Filed: Nov. 17, 2016
(86) PCT No.: PCT/JP2016/084022

§ 371 Date: Jun. 7, 2018

(30) Foreign Application Priority Data
Dec. 10, 2015 (JP) 2015-241601

(51) Int. Cl. H04N 1/00; B41J 11/66

(52) U.S. Cl. CPC H04N 1/00466; B41J 11/663; H04N 1/0032; H04N 1/00461; H04N 1/00411

(57) ABSTRACT

An information processing device including a display configured to display a print image on a cut setting screen, a touch panel provided to overlap the display and configured to detect a tap position on the cut setting screen, and a cut information setting unit configured to set cut information indicating that a position on a tape corresponding to a position on the print image overlapping a detected tap position in a length direction of the print image is a cut position in which the tape is cut in a width direction of the tape.

### TECHNICAL FIELD

The present invention relates to an information processing device that displays a print image, a program, a cut setting method using the information processing device, and a printing system.

### BACKGROUND ART

A tape printer that displays a print image of a character printed on a tape member on a touch panel and sets a cut position for cutting the tape member based on an operation on the touch panel has been known in the related art. In this tape printer, when a user draws a vertical line by a solid line, a cut position for a full cut is set, and when the user draws a vertical line by a broken line, a cut position for a half cut is set. Furthermore, when the user draws an oblique line with a touch pen such that the oblique line intersects a mark (vertical straight line) displayed by a vertical line drawn with the touch pen, a set cut position is canceled (see PTL 1).

### CITATION LIST

### Patent Literature

PTL 1: JP-A-2011-062985

### SUMMARY OF INVENTION

### Technical Problem

The inventor has found a problem below.

In the tape printer in the related art, since a vertical line needs to be drawn from the vicinity of an upper end of the touch panel to the vicinity of a lower end to set a cut position, it takes time to draw the vertical line. In addition, the tape printer in the related art does not allow a set cut position to be changed. Furthermore, the tape printer in the related art does not allow a cut method concerning a set cut position to be changed (for example, from a full cut to a half cut). In this way, the tape printer in the related art does not provide a user interface having a high degree of operability concerning an operation for setting a cut position, an operation for changing a cut position, or an operation for changing a cut method.

The present invention provides an information processing device capable of providing a user interface having a high degree of operability concerning an operation for setting a cut position, an operation for changing a cut position, or an operation for changing a cut method, a program, a cut setting method using the information processing device, and a printing system.

### Solution to Problem

An information processing device of the present invention includes a display configured to display a print image on a cut setting screen, a detecting unit provided to overlap the display and configured to detect a tap position on the cut setting screen, and a cut information setting unit configured to set cut information indicating that a position on a printing medium corresponding to a position on the print image overlapping a detected tap position in a length direction of the print image is a cut position in which the printing medium is cut in a width direction of the printing medium.

A cut setting method using an information processing device of the present invention includes displaying a print image on a cut setting screen by a display, detecting a tap position on the cut setting screen by a detecting unit provided to overlap the display, and setting cut information indicating that a position on a printing medium corresponding to a position on the print image overlapping the detected tap position in a length direction of the print image is a cut position in which the printing medium is cut in a width direction of the printing medium.

According to this configuration, when a tap operation is performed on the cut setting screen, cut information indicating that a position on the printing medium corresponding to a position on the print image overlapping a detected tap position in the length direction of the print image is a cut position is set. Thus, a user can set any position as a cut position only by performing a tap operation on a position overlapping a position on the print image corresponding to any position in which the printing medium is cut in the length direction of the print image. Therefore, according to the configuration, a user interface having a high degree of operability concerning an operation for setting a cut position can be provided.

In the above-described information processing device, it is desirable that the display displays a cut mark indicating the cut position in a position on the print image overlapping the detected tap position in the length direction of the print image.

According to this configuration, a cut position defined by set cut information can be displayed by the cut mark on the print image.

In this case, it is desirable that the display displays a message for confirming whether to set the cut position when a character serving as a print target is displayed in a position on the print image overlapping the detected tap position in the length direction of the print image on the cut setting screen.

When a character is displayed on a position on the print image overlapping the detected tap position in the length direction of the print image, this configuration can call user attention to whether to set a cut position to a position on the printing medium corresponding to the position.

In this case, it is desirable that the cut information setting unit corrects a cut position defined by cut information to provide a margin to at least one of the front and rear of the cut position in the length direction of the printing medium.

According to this configuration, a printed matter with the margin provided to the cut position can be obtained.

In the above-described information processing device, it is desirable that the display displays a gauge image indicating a dimension in the length direction of the print image on the cut setting screen.

According to this configuration, when a user wants to create printed matter having a predetermined length, an indicator for determining a position in which a tap operation or a drag operation is performed on the cut setting screen can be provided to the user.

A program of the present invention causes a computer to function as the above-described information processing device.

A printing system of the present invention is a printing system including an information processing device and a printing apparatus. The information processing device includes a display configured to display a print image on a cut setting screen, a detecting unit provided to overlap the display and configured to detect a tap position on the cut setting screen, a cut information setting unit configured to set cut information indicating that a position on a printing medium corresponding to a position on the print image overlapping a detected tap position in a length direction of the print image is a cut position in which the printing medium is cut in a width direction of the printing medium, and a transmitting unit configured to transmit the cut information to the printing apparatus. The printing apparatus includes a receiving unit configured to receive the cut information, and a cutting unit configured to cut the printing medium in the cut position defined by the received cut information.

According to this configuration, a printing medium is cut in a cut position set based on a tap operation.

Another information processing device of the present invention includes a display configured to display a print image and a cut mark indicating a cut position in which a printing medium is cut in a width direction of the printing medium on a cut setting screen, a detecting unit provided to overlap the display and configured to detect a tap operation on the cut mark, and a cut information setting unit configured to change, when the tap operation on the cut mark is detected, a cut method for the printing medium defined by cut information corresponding to the cut mark to another cut method.

Another cut setting method by an information processing device of the present invention includes displaying a print image and a cut mark indicating a cut position in which a printing medium is cut in a width direction of the printing medium on a cut setting screen by a display, detecting a tap operation on the cut mark by a detecting unit provided to overlap the display, and changing, when a tap operation on the cut mark is detected, a cut method for the printing medium defined by cut information corresponding to the cut mark to another method.

According to this configuration, when a tap operation is performed on the cut mark, a cut method defined by cut information corresponding to the cut mark is changed to a different cut method. Thus, a user can change a cut method only by performing a tap operation on the cut mark. Therefore, according to the configuration, a user interface having a high degree of operability concerning an operation for changing a cut method can be provided.

In the above-described information processing device, it is desirable that the display displays, in different colors, a plurality of kinds of the cut marks to be cut in different cut methods.

According to this configuration, a cut method defined by cut information corresponding to the cut mark can be indicated by color.

A program of the present invention causes a computer to function as the above-described information processing device.

Another information processing device of the present invention includes a display configured to display a print image and a cut mark indicating a cut position in which a printing medium is cut in a width direction of the printing medium on a cut setting screen, a detecting unit provided to overlap the display and configured to detect a drag completed position in which a drag operation on the cut mark is completed on the cut setting screen, and a cut information setting unit configured to change the cut position defined by cut information corresponding to the cut mark on which a drag operation is performed to a position on the printing medium corresponding to a position on the print image overlapping a detected drag completed position in a length direction of the print image.

Another cut setting method by an information processing device of the present invention includes displaying a print image and a cut mark indicating a cut position in which a printing medium is cut in a width direction of the printing medium on a cut setting screen by a display, detecting a drag completed position in which a drag operation on the cut mark is completed on the cut setting screen by a detecting unit provided to overlap the display, and changing the cut position defined by cut information corresponding to the cut mark on which a drag operation is performed to a position on the printing medium corresponding to a position on the print image overlapping a detected drag completed position in a length direction of the print image.

According to this configuration, when a drag operation is performed on the cut mark on the cut setting screen, a cut position defined by cut information corresponding to the cut mark on which the drag operation is performed is changed to a position on the printing medium corresponding to a position on the print image overlapping a detected drag completed position in the length direction of the print image. Thus, a user can change a cut position to any position only by performing a tap operation on the cut mark to a position overlapping a position on the print image corresponding to any position in which the printing medium is cut in the length direction of the print image. Therefore, according to the configuration, a user interface having a high degree of operability concerning an operation for changing a cut position can be provided.

A program of the present invention causes a computer to function as the above-described information processing device.

### BRIEF DESCRIPTION OF DRAWINGS

FIG. 1 is a diagram illustrating a printing system according to one embodiment of the present invention.

FIG. 2 is a block diagram of the printing system.

FIG. 3 is a block diagram illustrating a functional configuration of a device-side control circuit.

FIG. 4 is a flowchart illustrating a flow of processing executed by a smart device.

FIG. 5 is a diagram illustrating a character input screen.

FIG. 6 is a flowchart illustrating a flow of cut setting processing executed by the smart device.

FIG. 7 is a diagram illustrating a cut setting screen.

FIG. 8 is a diagram for describing cut information setting processing in the cut setting processing.

FIG. 9 is a diagram for describing cut method changing processing in the cut setting processing.

FIG. 10 is a diagram for describing cut position changing processing in the cut setting processing.

FIG. 11 is a diagram illustrating the cut setting screen that displays a message box.

FIG. 12 is a diagram illustrating label pieces with margins provided to the front and rear of a cut position.

FIG. 13 is a diagram illustrating the cut setting screen that displays a gauge image.

### DESCRIPTION OF EMBODIMENTS

One embodiment of the present invention is described below with reference to the accompanying drawings.

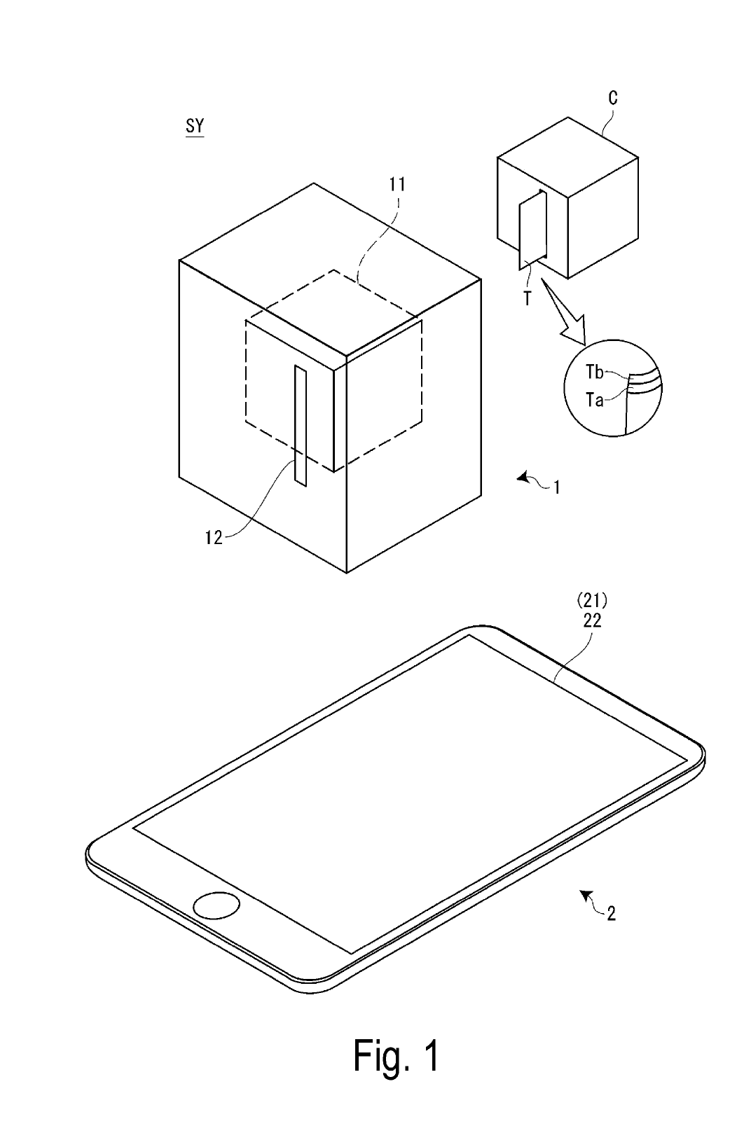

A printing system SY will be described based on FIG. 1. The printing system SY includes a tape printing apparatus 1 and a smart device 2. The tape printing apparatus land the smart device 2 are wirelessly connected to be able to communicate with each other.

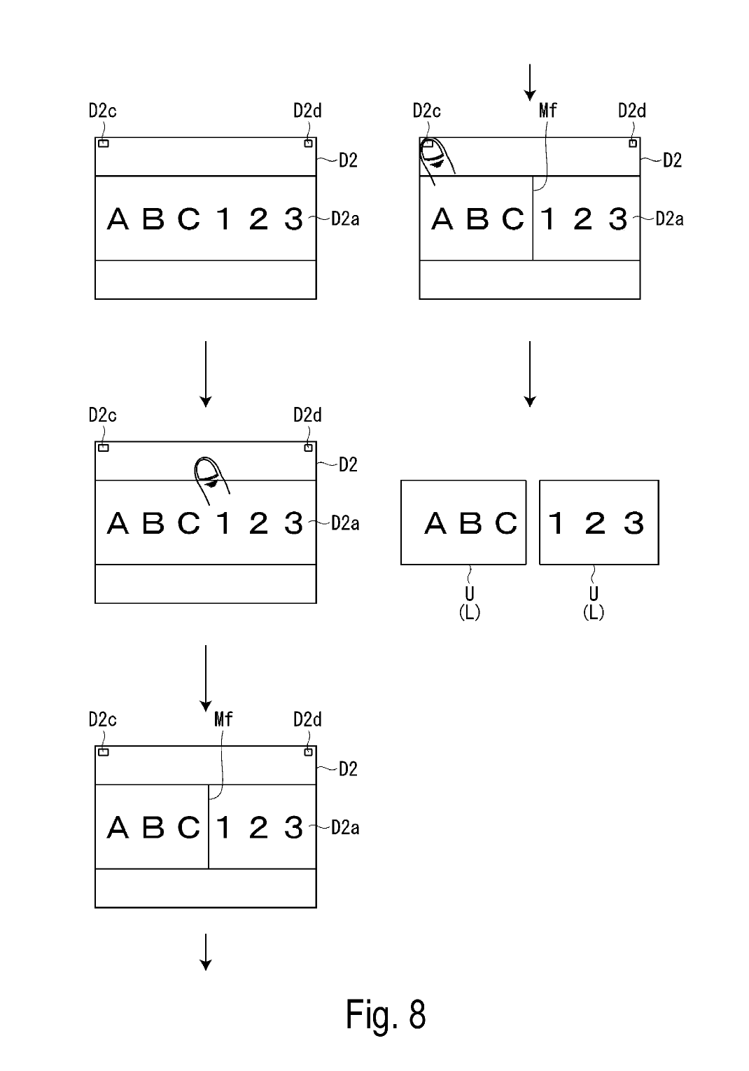

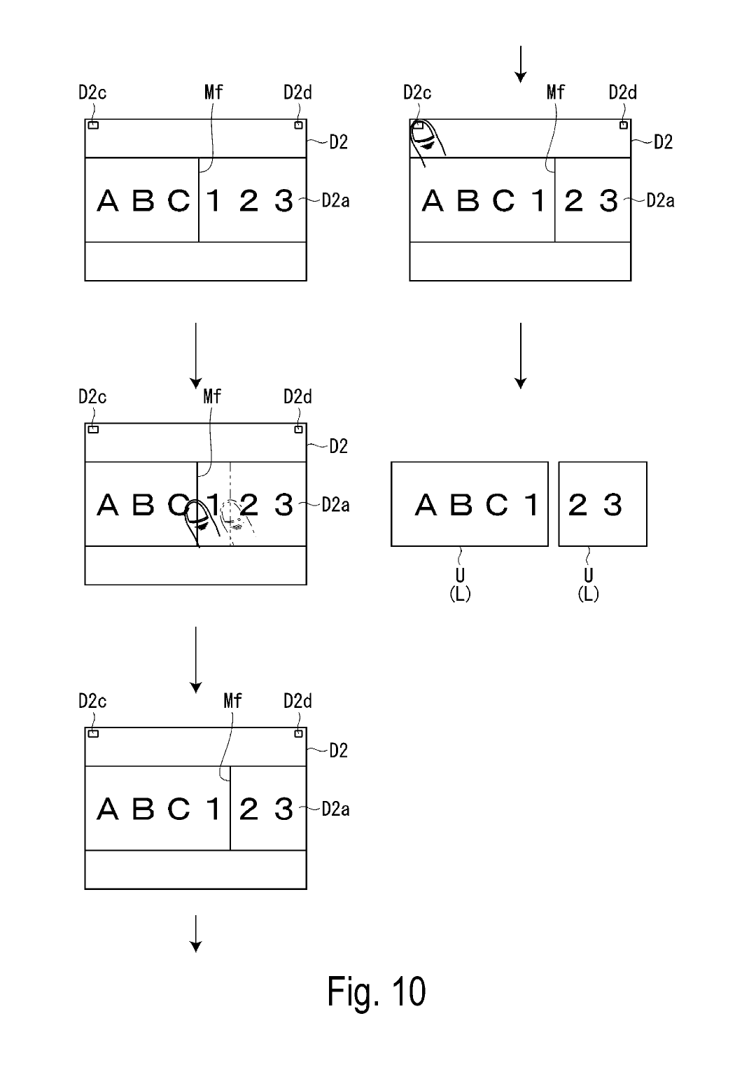

The tape printing apparatus 1 includes a cartridge installing portion 11 and a tape discharging port 12. The tape printing apparatus 1 performs printing and cutting on a tape T of a tape cartridge C installed on the cartridge installing portion 11 based on image data and cut information received from the smart device 2. A printed portion of the tape T discharged from the tape discharging port 12 is cut off and becomes a tape piece U (see FIG. 8 or FIG. 10). The tape T includes a tape main body Ta on which a print image is printed and a release sheet Tb releasably bonded to a bonding surface of the tape main body Ta. The tape main body Ta of the obtained tape piece U peeled off the release sheet Tb is bonded to a desired spot as a label L.

A smartphone, a tablet terminal, and the like, for example, can be used as the smart device 2. An application program compatible with the tape printing apparatus 1 (hereinafter referred to as a “compatible app”) is installed in the smart device 2. The smart device 2 includes a touch panel 22. The touch panel 22 detects an input, an editing operation, and the like of a character by a user. Note that the character is a concept including a letter, a symbol, a pictogram, and the like. The smart device 2 generates image data based on an input, an editing operation, and the like detected by the touch panel 22 and transmits the image data and cut information to the tape printing apparatus 1.

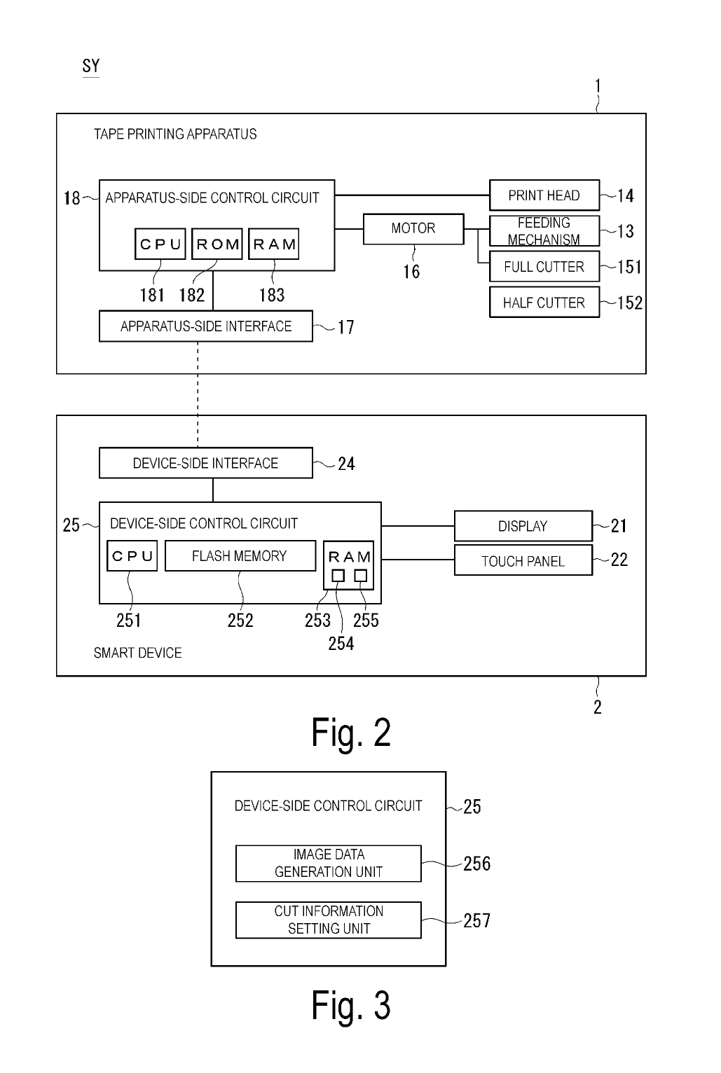

The tape printing apparatus 1 and the smart device 2 will be described based on FIG. 2. The tape printing apparatus 1 includes a feeding mechanism 13, a print head 14, a full cutter 151, a half cutter 152, a motor 16, an apparatus-side interface 17, and an apparatus-side control circuit 18.

The feeding mechanism 13 rotates platen rollers (not illustrated) accommodated in the tape cartridge C while the tape cartridge C is installed on the cartridge installing portion 11. In this way, the tape T and an ink ribbon (not illustrated) accommodated in the tape cartridge C are fed.

The print head 14 generates heat and is driven based on the received image data while the tape T and the ink ribbon are sandwiched between the platen rollers. In this way, ink of the ink ribbon is transferred to the tape T, and a character is then printed on the tape T.

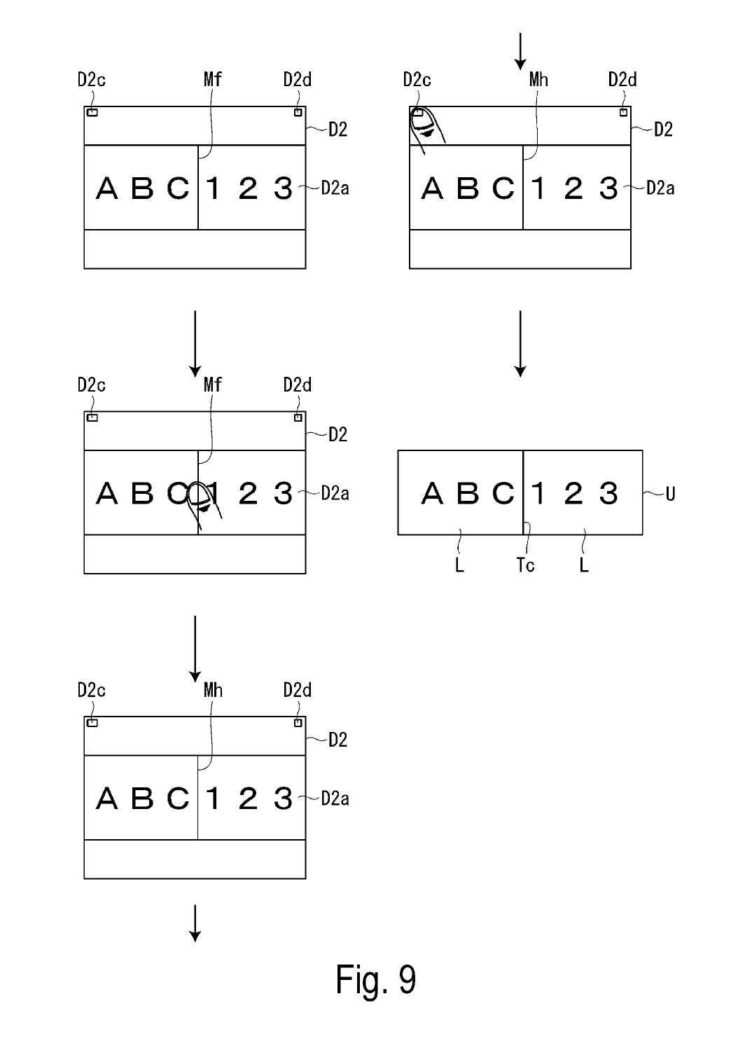

The full cutter 151 performs a full cut on the tape T. The full cut means a cut of both the tape main body Ta and the release sheet Tb in a width direction of the tape T. The full cut allows a printed portion of the tape T to be cut off. The half cutter 152 performs a half cut on the tape T. The half cut means a cut of the tape main body Ta without cutting the release sheet Tb. The half cut allows a tear Tc to be formed in the tape T and allows a plurality of labels L to be provided in one tape piece U (see FIG. 9). The motor 16 serves as a drive source of the feeding mechanism 13, the full cutter 151, and the half cutter 152.

The apparatus-side interface 17 transmits and receives various commands and various pieces of data to and from a device-side interface 24 described below.

The apparatus-side control circuit 18 controls each unit of the tape printing apparatus 1. The apparatus-side control circuit 18 includes a CPU 181 (Central Processing Unit), a ROM 182 (Read Only Memory), and a RAM 183 (Random Access Memory). The CPU 181 executes various processing by executing various programs stored in the ROM 182 by using the RAM 183.

The smart device 2 includes a display 21, the touch panel 22, the device-side interface 24, and a device-side control circuit 25.

The display 21 displays various screens. A color liquid crystal display, for example, can be used as the display 21. The touch panel 22 is provided to overlap the display 21 and detects various touch operations of a user.

The device-side interface 24 transmits and receives various commands and various pieces of data to and from the above-described apparatus-side interface 17.

The device-side control circuit 25 controls each unit of the smart device 2. The device-side control circuit 25 includes a CPU 251, a flash memory 252, and a RAM 253. The CPU 251 executes various processing by executing various programs (including a compatible app) stored in the flash memory 252 by using the RAM 253.

The RAM 253 includes a character string storage 254 and a cut information storage 255.

The character string storage 254 stores character string data. The character string data includes a plurality of pieces of character data. Each piece of character data includes code data of a character input from the touch panel 22 by a user and font data indicating a font size and a decoration content (for example, italics) of the character.

The cut information storage 255 stores cut information set by a cut information setting unit 257 described below. The cut information defines a cut position (distance from a tip of the tape T) in which the tape T is cut in the tape printing apparatus 1 and a cut method (full cut or half cut).

A configuration of each functional unit of the device-side control circuit 25 will be described based on FIG. 3. The device-side control circuit 25 includes an image data generation unit 256 and the cut information setting unit 257. Each of these functional units is achieved by cooperation between hardware constituting the device-side control circuit 25 and software such as a compatible app stored in the flash memory 252.

The image data generation unit 256 generates image data based on character string data stored in the character string storage 254. The generated image data is transmitted to the tape printing apparatus 1, and the tape printing apparatus 1 drives the print head 14 and performs printing on the tape T based on the received image data.

The cut information setting unit 257, which will be described later in detail, sets and changes cut information. The set cut information is transmitted to the tape printing apparatus 1, and the tape printing apparatus 1 cuts the tape T based on the received cut information. In other words, the tape printing apparatus 1 feeds the tape T such that a cut position on the tape T defined by the cut information reaches a position of a cutter corresponding to a cut method defined by the cut information, and then drives the cutter. In this way, a cut is performed in the cut position on the tape T defined by the cut information by the cut method defined by the cut information.

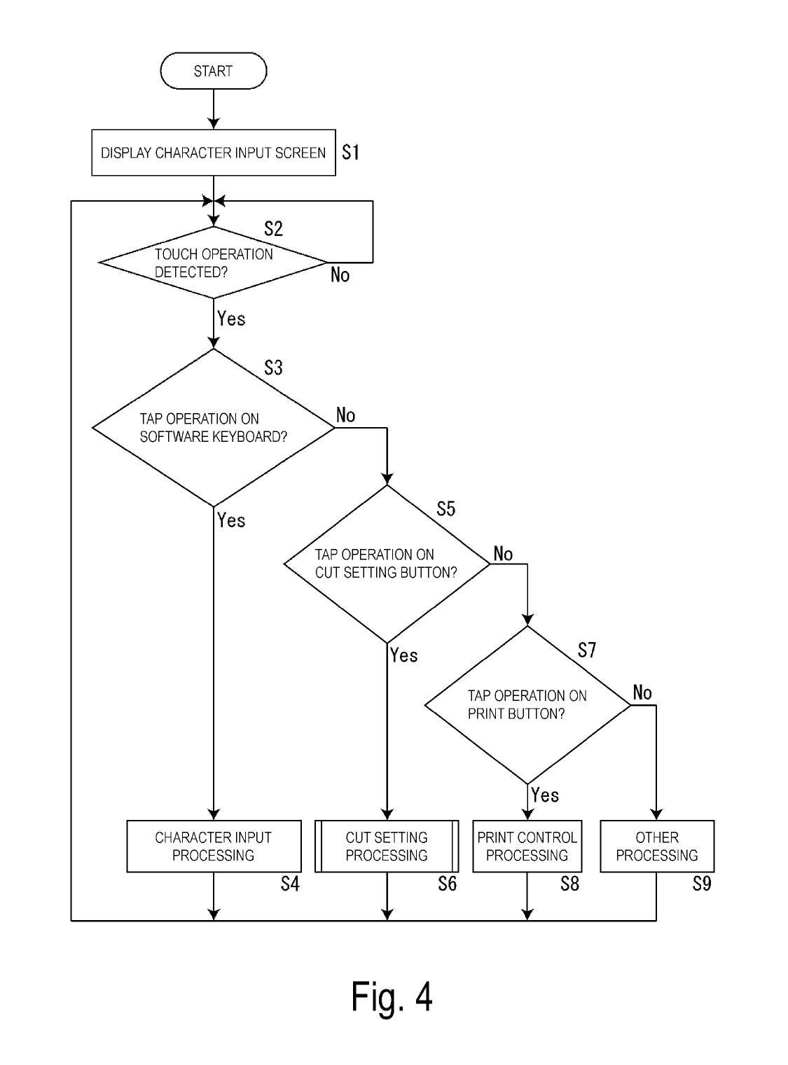

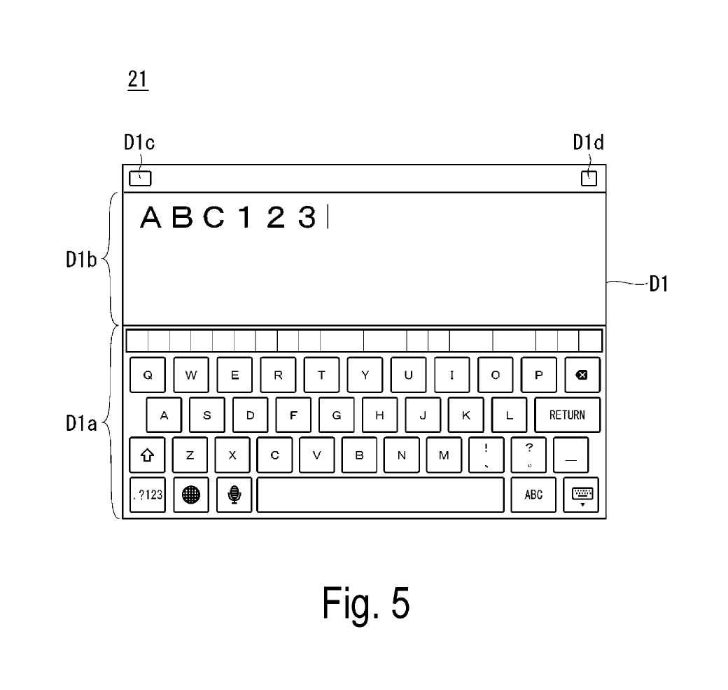

A processing procedure of the device-side control circuit 25 will be described based on FIG. 4. After a compatible app is activated, the device-side control circuit 25 causes the display 21 to display a character input screen D1 in Step S1. The character input screen D1 displays a software keyboard D1a, a character input box D1b, a print button D1c, and a cut setting button D1d (see FIG. 5).

The processing proceeds to Step S2, and the device-side control circuit 25 determines whether a touch operation on the character input screen D1 is detected by the touch panel 22. When the device-side control circuit 25 determines that a touch operation is detected (S2; Yes), the processing proceeds to Step S3. When the device-side control circuit 25 determines that a touch operation is not detected (S2; No), Step S2 is repeated and the device-side control circuit 25 waits for a touch operation on the character input screen D1.

In Step S3, the device-side control circuit 25 determines whether the touch operation detected in Step S2 is a tap operation on the software keyboard D1a. When the device-side control circuit 25 determines that it is a tap operation on the software keyboard D1a (S3; Yes), the processing proceeds to Step S4. On the other hand, when the device-side control circuit 25 determines that it is not a tap operation on the software keyboard D1a (S3; No), the processing proceeds to Step S5.

In Step S4, the device-side control circuit 25 performs character input processing. In the character input processing, the device-side control circuit 25 stores code data corresponding to a key of the software keyboard D1a on which a tap operation is performed in the character string storage 254. The character input box D1b displays an input character based on code data stored in the character string storage 254. When the device-side control circuit 25 completes the character input processing, the processing returns to Step S2 and the device-side control circuit 25 waits for a touch operation on the character input screen D1.

In Step S5, the device-side control circuit 25 determines whether the touch operation detected in Step S2 is a tap operation on the cut setting button D1d. When the device-side control circuit 25 determines that it is a tap operation on the cut setting button D1d (S5; Yes), the processing proceeds to Step S6. On the other hand, when the device-side control circuit 25 determines that it is not a tap operation on the cut setting button D1d (S5; No), the processing proceeds to Step S7.

In Step S6, the device-side control circuit 25 performs cut setting processing described later. When the device-side control circuit 25 completes the cut setting processing, the processing returns to Step S2 and the device-side control circuit 25 waits for a touch operation on the character input screen D1.

In Step S7, the device-side control circuit 25 determines whether the touch operation detected in Step S2 is a tap operation on the print button D1c. When the device-side control circuit 25 determines that it is a tap operation on the print button (S7; Yes), the processing proceeds to Step S8. On the other hand, when the device-side control circuit 25 determines that it is not a tap operation on the print button (S7; No), the processing proceeds to Step S9.

In Step S8, the device-side control circuit 25 performs print control processing. In the print control processing, the device-side control circuit 25 generates image data and transmits the image data and cut information to the tape printing apparatus 1. When the device-side control circuit 25 completes the print control processing, the processing returns to Step S2 and the device-side control circuit 25 waits for a touch operation on the character input screen D1.

In Step S9, the device-side control circuit 25 performs the other processing. When the device-side control circuit 25 completes the other processing, the processing returns to Step S2 and the device-side control circuit 25 waits for a touch operation on the character input screen D1.

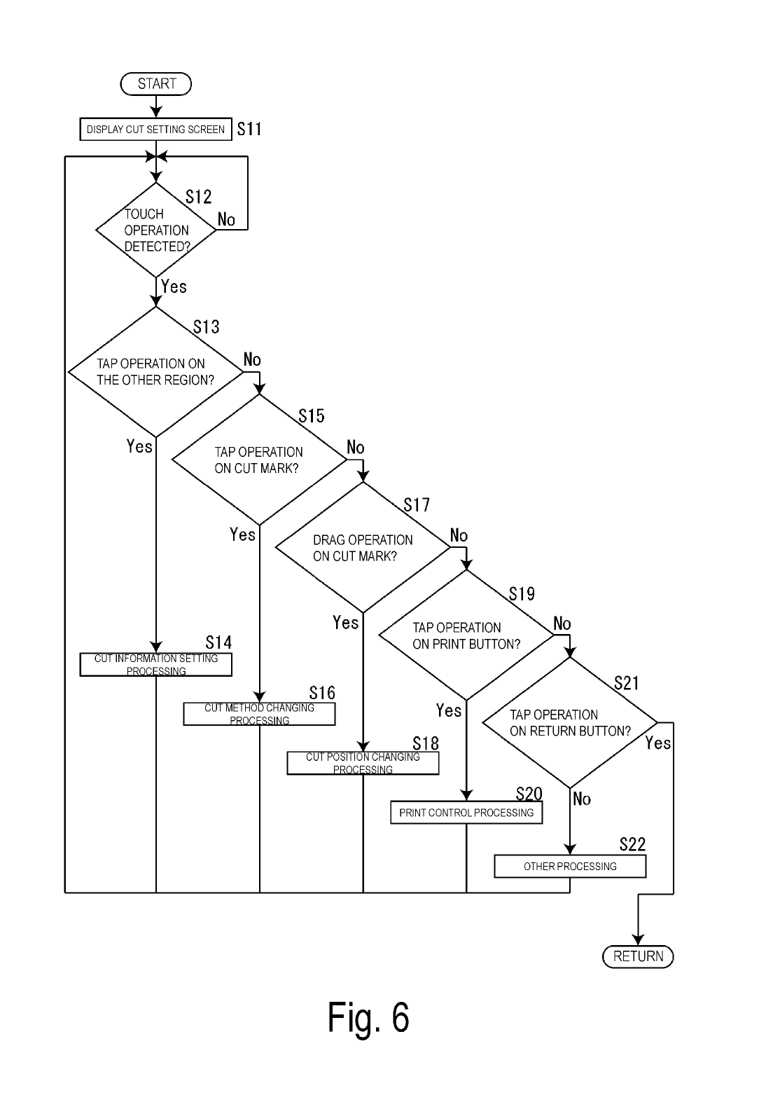

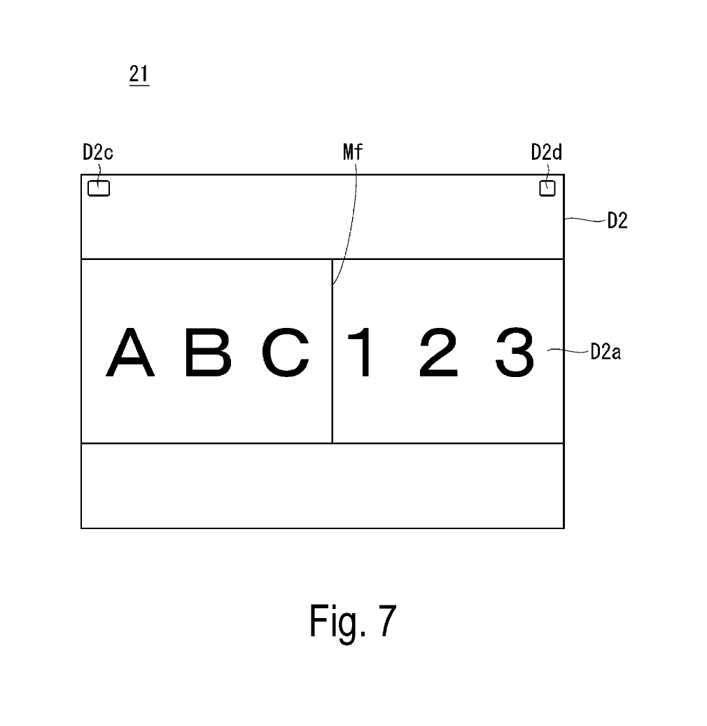

A flow of the cut setting processing in Step S6 in the flowchart of FIG. 4 will be described based on FIG. 6. In Step S11, the device-side control circuit 25 displays a cut setting screen D2. The cut setting screen D2 displays a print image D2a, a cut mark M, a print button D2c, and a return button D2d (see FIG. 7).

The cut mark M displays a cut position defined by corresponding cut information on the print image D2a. The cut mark M includes a full cut mark Mf and a half cut mark Mh. The full cut mark Mf indicates that a cut method defined by corresponding cut information is a full cut. In other words, the full cut mark Mf indicates that a full cut is performed in that position. The half cut mark Mh indicates that a cut method defined by corresponding cut information is a half cut. In other words, the half cut mark Mh indicates that a half cut is performed in that position. The full cut mark Mf and the half cut are displayed in different colors. For example, the full cut mark Mf is displayed in blue (black in the drawing), and the half cut mark Mh is displayed in yellow (gray in the drawing).

The processing proceeds to Step S12, and the device-side control circuit 25 determines whether a touch operation on the cut setting screen D2 is detected by the touch panel 22. When the device-side control circuit 25 determines that a touch operation is detected (S12; Yes), the processing proceeds to Step S13. When the device-side control circuit 25 determines that a touch operation is not detected (S12; No), Step S12 is repeated and the device-side control circuit 25 waits for a touch operation on the cut setting screen D2.

In Step S13, the device-side control circuit 25 determines whether the touch operation detected in Step S12 is a tap operation on a region other than the cut mark M, the print button D2c, and the return button D2d (hereinafter referred to as “the other region”). When the device-side control circuit 25 determines that it is a tap operation on the other region (S13; Yes), the processing proceeds to Step S14. On the other hand, when the device-side control circuit 25 determines that it is not a tap operation on the other region (S13; No), the processing proceeds to Step S15. Note that a tap operation on the other region may be a tap operation on the inside or the outside of the print image D2a.

In Step S14, the device-side control circuit 25 performs cut information setting processing described later. When the device-side control circuit 25 completes the cut information setting processing, the processing returns to Step S12 and the device-side control circuit 25 waits for a touch operation on the cut setting screen D2.

In Step S15, the device-side control circuit 25 determines whether the touch operation detected in Step S12 is a tap operation on the cut mark M. When the device-side control circuit 25 determines that it is a tap operation on the cut mark M (S15; Yes), the processing proceeds to Step S16. On the other hand, when the device-side control circuit 25 determines that it is not a tap operation on the cut mark M (S15; No), the processing proceeds to Step S17.

In Step S16, the device-side control circuit 25 performs cut method changing processing described later. When the device-side control circuit 25 completes the cut method changing processing, the processing returns to Step S12 and the device-side control circuit 25 waits for a touch operation on the cut setting screen D2.

In Step S17, the device-side control circuit 25 determines whether the touch operation detected in Step S12 is a drag operation (swipe operation) on the cut mark M. When the device-side control circuit 25 determines that it is a drag operation on the cut mark M (S17; Yes), the processing proceeds to Step S18. On the other hand, when the device-side control circuit 25 determines that it is not a drag operation on the cut mark M (S17; No), the processing proceeds to Step S19.

In Step S18, the device-side control circuit 25 performs cut position changing processing described later. When the device-side control circuit 25 completes the cut position changing processing, the processing returns to Step S12 and the device-side control circuit 25 waits for a touch operation on the cut setting screen D2.

In Step S19, the device-side control circuit 25 determines whether the touch operation detected in Step S12 is a tap operation on the print button D2c. When the device-side control circuit 25 determines that it is a tap operation on the print button (S19; Yes), the processing proceeds to Step S20. On the other hand, when the device-side control circuit 25 determines that it is not a tap operation on the print button (S19; No), the processing proceeds to Step S21.

In Step S20, the device-side control circuit 25 performs print control processing. In the print control processing, the device-side control circuit 25 generates image data and transmits the image data and cut information to the tape printing apparatus 1. When the device-side control circuit 25 completes the print control processing, the processing returns to Step S12.

In Step S21, the device-side control circuit 25 determines whether the touch operation detected in Step S12 is a tap operation on the return button D2d. When the device-side control circuit 25 determines that it is a tap operation on the return button D2d (S21; Yes), the processing returns to Step S2 in the flowchart of FIG. 4 and the device-side control circuit 25 waits for a touch operation on the character input screen D1. On the other hand, when the device-side control circuit 25 determines that it is not a tap operation on the return button D2d (S21; No), the processing proceeds to Step S22.

In Step S22, the device-side control circuit 25 performs the other processing. When the device-side control circuit 25 completes the other processing, the processing returns to Step S12 and the device-side control circuit 25 waits for a touch operation on the cut setting screen D2.

The cut information setting processing in Step S14 in the flowchart of FIG. 6 will be described based on FIG. 8. As mentioned above, the cut information setting processing is processing performed when a tap operation on the other region is detected on the cut setting screen D2. In the following description, it will be described by using, as an example, the print image D2a indicating a state where a character string “ABC123” is printed on the tape T.

Note that at a point in time when the cut setting screen D2 is displayed, cut information (hereinafter referred to as “cut information a”) indicating a rear position of “3” of “ABC123” as a cut position and a full cut as a cut method, is previously stored in the cut information storage 255.

In the cut information setting processing, the cut information setting unit 257 sets cut information indicating that a position on the tape T corresponding to a position on the print image D2a overlapping a detected tap position in a length direction of the print image D2a is a cut position and a full cut is a cut method. The length direction of the print image D2a means a length direction of an image of the tape T included in the print image D2a.

Further, the display 21 displays the full cut mark Mf in the position on the print image D2a overlapping the detected tap position in the length direction of the print image D2a.

For example, as illustrated in FIG. 8, it is assumed that a tap operation is performed on a position between “C” and “1” of “ABC123” in the length direction of the print image D2a on the cut setting screen D2. In this case, the cut information setting unit 257 sets cut information (hereinafter referred to as “cut information b”) indicating that a position on the tape T (position between “C” and “1” on the tape T) corresponding to a position on the print image D2a overlapping a detected tap position in the length direction of the print image D2a (position between “C” and “1” on the print image D2a) is a cut position and a full cut is a cut method. Further, the full cut mark Mf is displayed in the position on the print image D2a overlapping the detected tap position in the length direction of the print image D2a (position between “C” and “1” on the print image D2a) on the cut setting screen D2.

When the cut information b is set in such a manner and the print button D2c is then tapped, the cut information a and the cut information b are transmitted to the tape printing apparatus 1. The tape printing apparatus 1 performs the full cut in the position on the tape T defined by the cut information b and the full cut in the position on the tape T defined by the cut information a based on the received cut information a and cut information b. In other words, the tape printing apparatus 1 performs the full cut in the position between “C” and “1” and the full cut in the rear position of “3”. As a result, a tape piece U on which “ABC” is printed and a tape piece U on which “123” is printed are obtained.

Thus, when a user wants to create the tape piece U on which “ABC” is printed and the tape piece U on which “123” is printed, the user does not need to input and print a character repeatedly in such a way that “ABC” is input and printed, and then “123” is input and printed. The tape piece U on which “ABC” is printed and the tape piece U on which “123” is printed can be obtained at once by inputting “ABC123” all together and then setting a cut position with a tap between “C” and “1” and performing printing.

The cut method changing processing in Step S16 in the flowchart of FIG. 6 will be described based on FIG. 9. As mentioned above, the cut method changing processing is processing performed when a tap operation on the cut mark M is detected on the cut setting screen D2.

In the cut method changing processing, the cut information setting unit 257 changes a cut method defined by cut information corresponding to the cut mark M on which a tap operation is performed to another cut method. In other words, when a tap operation is performed on the full cut mark Mf on the cut setting screen D2, the cut information setting unit 257 changes a cut method defined by cut information corresponding to the full cut mark Mf on which the tap operation is performed from a full cut to a half cut. Similarly, when a tap operation is performed on the half cut mark Mh on the cut setting screen D2, the cut information setting unit 257 changes a cut method defined by cut information corresponding to the half cut mark Mh on which the tap operation is performed from a half cut to a full cut.

Further, when a tap operation is performed on the full cut mark Mf on the cut setting screen D2, the display 21 displays the half cut mark Mh instead of the full cut mark Mf. Similarly, when a tap operation is performed on the half cut mark Mh on the cut setting screen D2, the display 21 displays the full cut mark Mf instead of the half cut mark Mh.

For example, as mentioned above, after the cut information b indicating the position between “C” and “1” of “ABC123” as the cut position and a full cut as the cut method is set, it is assumed that a tap operation is performed on the full cut mark Mf corresponding to the cut information b on the cut setting screen D2 as illustrated in FIG. 9. In this case, the cut information setting unit 257 changes the cut method defined by the cut information b corresponding to the full cut mark Mf on which the tap operation is performed to a half cut. Further, the half cut mark Mh instead of the full cut mark Mf is displayed on the cut setting screen D2.

When the cut method of the cut information b is changed from the full cut to the half cut in such a manner and the print button D2c is then tapped, the cut information a and the cut information b are transmitted to the tape printing apparatus 1. The tape printing apparatus 1 performs the half cut in the position on the tape T defined by the cut information b and the full cut in the position on the tape T defined by the cut information a based on the received cut information a and cut information b. In other words, the tape printing apparatus 1 performs the half cut in the position between “C” and “1” and the full cut in the rear position of “3”. As a result, a tear Tc is formed in the position between “C” and “1”, and a tape piece U including a label L on which “ABC” is printed and a label L on which “123” is printed is obtained by this tear Tc.

The cut position changing processing in Step S18 in the flowchart of FIG. 6 will be described based on FIG. 10. As mentioned above, the cut position changing processing is processing performed when a drag operation on the cut mark M is detected on the cut setting screen D2.

In the cut position changing processing, the cut information setting unit 257 changes a cut position defined by cut information corresponding to the cut mark M on which a drag operation is performed.

Further, when a drag operation is performed on the cut mark M on the cut setting screen D2, the display 21 displays the cut mark M moving with the drag operation.

For example, as mentioned above, after the cut information b indicating the position between “C” and “1” of “ABC123” as the cut position and a full cut as the cut method is set, it is assumed that a drag operation is performed on the full cut mark Mf corresponding to the cut information b to a position between “1” and “2” on the cut setting screen D2 as illustrated in FIG. 10. In this case, the cut information setting unit 257 changes the cut position defined by the cut information b corresponding to the full cut mark Mf on which the drag operation is performed to a position on the tape T (position between “1” and “2” on the tape T) corresponding to a position on the print image D2a overlapping a detected drag completed position in the length direction of the print image D2a (position between “1” and “2” on the print image D2a). Furthermore, the display 21 displays the full cut mark Mf moving with the drag operation. As a result, the full cut mark Mf is displayed in the position on the print image D2a overlapping the detected drag completed position in the length direction of the print image D2a (position between “1” and “2” on the print image D2a) on the cut setting screen D2.

When the cut position in the cut information b is changed in such a manner and the print button D2c is then tapped, the cut information a and the cut information b are transmitted to the tape printing apparatus 1. The tape printing apparatus 1 performs the full cut in the position on the tape T defined by the cut information b and the full cut in the position on the tape T defined by the cut information a based on the received cut information a and cut information b. In other words, the tape printing apparatus 1 performs the full cut in the position between “1” and “2” and the full cut in the rear position of “3”. As a result, a tape piece U on which “ABC1” is printed and a tape piece U on which “23” is printed are obtained.

As described above, the smart device 2 in the embodiment includes the display 21, the touch panel 22, and the cut information setting unit 257. The display 21 displays the print image D2a on the cut setting screen D2. The touch panel 22 is provided to overlap the display 21 and detects a tap position on the cut setting screen D2. The cut information setting unit 257 sets cut information indicating that a position on the tape T corresponding to a position on the print image D2a overlapping a detected tap position in the length direction of the print image D2a is a cut position.

According to this configuration, when a tap operation is performed on the cut setting screen D2, cut information indicating that a position on the tape T corresponding to a position on the print image D2a overlapping a detected tap position in the length direction of the print image D2a is a cut position is set. Thus, a user can set any position as a cut position only by performing a tap operation on a position overlapping a position on the print image D2a corresponding to any position in which the tape T is cut in the length direction of the print image D2a. Therefore, according to the configuration, a user interface having a high degree of operability concerning an operation for setting a cut position can be provided.

Further, in the smart device 2 in the embodiment, the display 21 displays the cut mark M in a position on the print image D2a overlapping a detected tap position in the length direction of the print image D2a.

According to this configuration, a cut position defined by set cut information can be displayed by the cut mark M on the print image D2a.

Further, the smart device 2 in the embodiment includes the display 21, the touch panel 22, and the cut information setting unit 257. The display 21 displays the print image D2a and the cut mark M on the cut setting screen D2. The touch panel 22 is provided to overlap the display 21 and detects a drag completed position in which a drag operation on the cut mark M is completed on the cut setting screen D2. The cut information setting unit 257 changes a cut position defined by cut information corresponding to the cut mark M on which the drag operation is performed to a position on the tape T corresponding to a position on the print image D2a overlapping the detected drag completed position in the length direction of the print image D2a.

According to this configuration, when a drag operation is performed on the cut mark M on the cut setting screen D2, a cut position defined by cut information corresponding to the cut mark M on which the drag operation is performed is changed to a position on the tape T corresponding to a position on the print image D2a overlapping a detected drag completed position in the length direction of the print image D2a. Thus, a user can change a cut position to any position only by performing a drag operation on the cut mark M to a position overlapping a position on the print image D2a corresponding to any position in which the tape T is cut in the length direction of the print image D2a. Therefore, according to the configuration, a user interface having a high degree of operability concerning an operation for changing a cut position can be provided.

Further, the smart device 2 in the embodiment includes the display 21, the touch panel 22, and the cut information setting unit 257. The display 21 displays the print image D2a and the cut mark M on the cut setting screen D2. The touch panel 22 is provided to overlap the display 21 and detects a tap operation on the cut mark M. When a tap operation on the cut mark M is detected, the cut information setting unit 257 changes a cut method defined by cut information corresponding to the cut mark M to a different cut method.

According to this configuration, when a tap operation is performed on the cut mark M, a cut method defined by cut information corresponding to the cut mark M is changed to a different cut method. Thus, a user can change a cut method only by performing a tap operation on the cut mark M. Therefore, according to the configuration, a user interface having a high degree of operability in an operation for changing a cut method can be provided.

Further, in the smart device 2 in the embodiment, the display 21 displays, in different colors, two kinds of the cut mark M (full cut mark Mf and half cut mark Mh) different in a cut method.

According to this configuration, a cut method defined by cut information corresponding to the cut mark M can be indicated by color. In other words, by looking at a color of the cut mark M, a user can recognize whether a full cut or a half cut is performed in a cut position indicated by the cut mark M.

Note that the full cutter 151 and the half cutter 152 are one example of a “cutting unit”. The apparatus-side interface 17 is one example of a “receiving unit”. The display 21 is one example of a “display”. The touch panel 22 is one example of a “detecting unit”. The device-side interface 24 is one example of a “transmitting unit”. The tape T is one example of a “printing medium”.

The present invention is not limited to the above-described embodiments, and it goes without saying that various configurations can be adopted without departing from the purpose of the present invention. For example, the embodiment can be changed to the following manner.

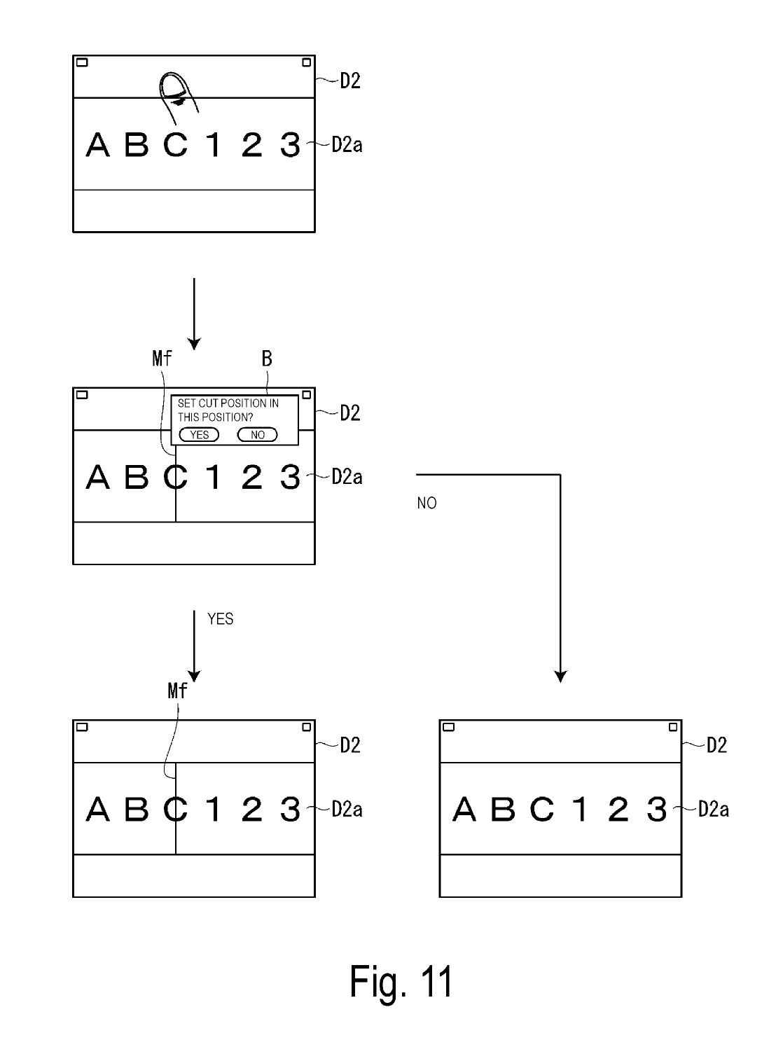

As illustrated in FIG. 11, when a character (for example, “C”) is displayed in a position on the print image D2a overlapping a detected tap position in the length direction of the print image D2a on the cut setting screen D2, the display 21 may display a message box B together with the full cut mark Mf. In the message box B, choices of “YES” and “NO” are displayed together with a message saying, “CONFIGURE CUT POSITION IN THIS POSITION?”.

Then, when a user taps a choice of “YES”, the cut information setting unit 257 sets cut information indicating that a position on the tape T (position overlapping “C” on the tape T) corresponding to a position on the print image D2a overlapping a detected tap position (position overlapping “C” on the print image D2a) is a cut position. Further, the display 21 continues to display the full cut mark Mf in the position on the print image D2a overlapping the detected tap position (position overlapping “C” on the print image D2a). Note that the display 21 may change a display color, a flashing state, or the like of the full cut mark Mf before and after the choice of “YES” is tapped.

On the other hand, when the user taps a choice of “NO”, the cut information setting unit 257 does not set cut information. Further, the display 21 turns off the display of the full cut mark Mf displayed in the position on the print image D2a overlapping the detected tap position (position overlapping “C” on the print image D2a).

Similarly, also when a drag operation is performed on the cut mark M to a position overlapping a character in the length direction of the print image D2a on the cut setting screen D2, the display 21 may display the message box B.

When a tap operation or a drag operation is performed on a position overlapping a character in the length direction of the print image D2a, this configuration can call user attention to whether to set a cut position to a position on the tape T corresponding to the position. In this way, even when the user accidentally performs a tap operation or a drag operation on a position overlapping a character in the length direction of the print image D2a, a full cut or a half cut performed in the position overlapping the character can be suppressed.

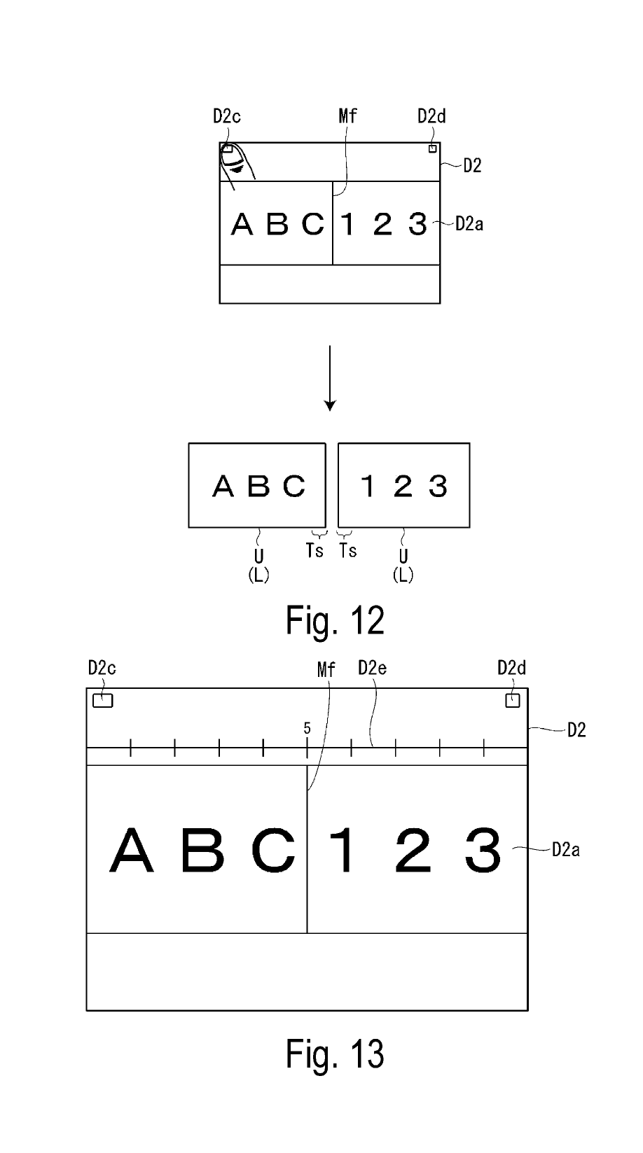

Further, as illustrated in FIG. 12, the smart device 2 may provide a margin Ts to at least one of the front and rear, in the length direction of the tape T, of a cut position defined by cut information set based on a touch operation on the cut setting screen D2. In this case, the image data generation unit 256 generates image data with the margins provided to the front and rear of the cut position defined by the set cut information. Further, the cut information setting unit 257 corrects the cut position defined by the cut information so as to provide the margin Ts to at least one of the front and rear of the cut position in the length direction of the tape T. In this way, for example, when the margins Ts are provided to the front and rear of a cut position set to a position between “C” and “1” in the length direction of the tape T as illustrated in FIG. 12, the margin Ts is provided to a rear end portion (rear of “C”) in a tape piece U on which “ABC” is printed. The margin Ts is also provided to a front end portion (front of “1”) in a tape piece U on which “123” is printed.

According to this configuration, the label L with the margin Ts provided to the cut position can be obtained. Note that whether to provide the margin Ts to the cut position may be selected by a user. Further, the display 21 may display the print image D2a with the margin Ts provided to the cut position.

In addition, as illustrated in FIG. 13, the display 21 may display a gauge image D2e on the cut setting screen D2. The gauge image D2e indicates dimensions in the length direction of the print image D2a.

According to this configuration, when a user wants to create a label L having a predetermined length, an indicator for determining a position in which a tap operation is performed on the cut setting screen D2 or a position in which a drag operation is completed can be provided to the user. Thus, when the user wants to obtain a label L having a length of 5 cm, for example, the user may tap a position on the gauge image D2e in which the gauge image D2e indicates “5 cm” or a position overlapping this in the length direction of the print image D2a.

In the cut position changing processing, the cut information setting unit 257 may cancel cut information corresponding to the cut mark M on which a tap operation is performed instead of changing a cut method defined by the cut information corresponding to the cut mark M. In this case, when a tap operation is performed on the cut mark M on the cut setting screen D2, the display 21 turns off the display of the cut mark M. Furthermore, when a first tap operation is performed on the cut mark M, the cut information setting unit 257 may change a cut method defined by cut information corresponding to the cut mark M, and when a second tap operation is performed, the cut information setting unit 257 may cancel the cut information corresponding to the cut mark M. In this case, the display 21 changes the display from, for example, the full cut mark Mf to the half cut mark Mh in response to the first tap operation, and then turns off the display of the half cut mark Mh in response to the second rap operation.

In the cut information setting processing, the cut information setting unit 257 may configure a cut method defined by set cut information as a half cut instead of a full cut. In this case, when a tap operation is performed on the other region on the cut setting screen D2, the display 21 displays the half cut mark Mh instead of the full cut mark Mf.

When the tape cartridge C, in which the tape T having a limitation on a cut by a material, a thickness, or the like is accommodated, is installed on the tape printing apparatus 1, the smart device 2 may display a cut disabling mark indicating a cut is disabled instead of the cut mark M on the display 21. In other words, the smart device 2 acquires cartridge information indicating a type of the tape cartridge C installed on the tape printing apparatus 1 from the tape printing apparatus 1. When the acquired cartridge information indicates the tape cartridge C in which the tape T having a limitation on a cut is accommodated, the smart device 2 displays the cut disabling mark instead of the cut mark M. It is desirable that the cut disabling mark is in a color (for example, red) different from colors of the full cut mark Mf and the half cut mark Mh. Furthermore, the display 21 may display a message for confirming whether to print a cut line for a user to cut the tape T with scissors or the like in a position on the tape T corresponding to the cut disabling mark.

As an information processing device, for example, a personal computer including the touch panel 22 may be used instead of the smart device 2.

The printing system SY may include, as a printing apparatus, a printing apparatus that performs printing on a paper roll, for example, instead of the tape printing apparatus 1.

The present invention can provide the information processing device as a program that functions as the smart device 2 in the embodiment (for example, the above-described compatible app) and a recording medium (CD-ROM, flash memory, or the like) that stores the program.

### REFERENCE SIGNS LIST

D2 . . . Cut setting screen, D2a . . . Print image, D2c . . . Print button, D2d . . . Return button, L . . . Label, Mf . . . Full cut mark, U . . . Tape piece

1. An information processing device comprising:
a display configured to display a print image on a cut setting screen;
a detecting unit provided to overlap the display and configured to detect a tap position on the cut setting screen; and
a cut information setting unit configured to set cut information indicating that a position on a printing medium corresponding to a position on the print image overlapping a detected tap position in a length direction of the print image is a cut position in which the printing medium is cut in a width direction of the printing medium.

2. The information processing device according to claim 1, wherein
the display displays a cut mark indicating the cut position in a position on the print image overlapping the detected tap position in the length direction of the print image.

3. The information processing device according to claim 1, wherein
the display displays a message for confirming whether to set the cut position when a character serving as a print target is displayed in a position on the print image overlapping the detected tap position in the length direction of the print image on the cut setting screen.

4. The information processing device according to claim 1, wherein
the cut information setting unit corrects the cut position to provide a margin to at least one of the front or rear of the cut position defined by the cut information in the length direction of the printing medium.

5. The information processing device according to claim 1, wherein
the display displays a gauge image indicating a dimension in the length direction of the print image on the cut setting screen.

6. A program causing a computer to function as the information processing device according to claim 1.

7. A cut setting method by an information processing device, the cut setting method comprising:
displaying a print image on a cut setting screen by a display;
detecting a tap position on the cut setting screen by a detecting unit provided to overlap the display; and
setting cut information indicating that a position on a printing medium corresponding to a position on the print image overlapping a detected tap position in a length direction of the print image, is a cut position in which the printing medium is cut in a width direction of the printing medium.

8. A printing system including an information processing device and a printing apparatus, wherein
the information processing device includes
a display configured to display a print image on a cut setting screen,
a detecting unit provided to overlap the display and configured to detect a tap position on the cut setting screen,
a cut information setting unit configured to set cut information indicating that a position on a printing medium corresponding to a position on the print image overlapping a detected tap position in a length direction of the print image is a cut position in which the printing medium is cut in a width direction of the printing medium, and
a transmitting unit configured to transmit the cut information to the printing apparatus, and
the printing apparatus includes
a receiving unit configured to receive the cut information, and
a cutting unit configured to cut the printing medium in the cut position defined by the received cut information.

9. An information processing device comprising:
a display configured to display a print image and a cut mark indicating a cut position in which a printing medium is cut in a width direction of the printing medium on a cut setting screen;
a detecting unit provided to overlap the display and configured to detect a tap operation on the cut mark; and
a cut information setting unit configured to change, when the tap operation on the cut mark is detected, a cut method for the printing medium defined by cut information corresponding to the cut mark to another cut method.

10. The information processing device according to claim 9, wherein
the display displays, in different colors, a plurality of kinds of the cut marks to be cut in different cut methods.

11. A program causing a computer to function as the information processing device according to claim 10.

12. A cut setting method by an information processing device, the cut setting method comprising:
displaying a print image and a cut mark indicating a cut position in which a printing medium is cut in a width direction of the printing medium on a cut setting screen by a display;
detecting a tap operation on the cut mark by a detecting unit provided to overlap the display; and
changing, when a tap operation on the cut mark is detected, a cut method for the printing medium defined by cut information corresponding to the cut mark to another cut method.

13. An information processing device comprising:
a display configured to display a print image and a cut mark indicating a cut position in which a printing medium is cut in a width direction of the printing medium on a cut setting screen;
a detecting unit provided to overlap the display and configured to detect a drag completed position in which a drag operation on the cut mark is completed on the cut setting screen; and
a cut information setting unit configured to change the cut position defined by cut information corresponding to the cut mark on which a drag operation is performed to a position on the printing medium corresponding to a position on the print image overlapping a detected drag completed position in a length direction of the print image.

14. A program causing a computer to function as the information processing device according to claim 13.

15. A cut setting method by an information processing device, the cut setting method comprising:
displaying a print image and a cut mark indicating a cut position in which a printing medium is cut in a width direction of the printing medium on a cut setting screen by a display;
detecting a drag completed position in which a drag operation on the cut mark is completed on the cut setting screen by a detecting unit provided to overlap the display; and
changing the cut position defined by cut information corresponding to the cut mark on which a drag operation is performed to a position on the printing medium corresponding to a position on the print image overlapping a detected drag completed position in a length direction of the print image.
